(19) United States
(12) Patent Application Publication
(10) Pub. No.: US 2026/0273969 A1
(43) Pub. Date: Sep. 17, 2026

(54) ROLL PAPER PRINTER

(71) Applicant: SEIKO EPSON CORPORATION, TOKYO (JP)

(72) Inventor: Nobuhiro INOUE, MATSUMOTO-SHI (JP)

(21) Appl. No.: 19/566,114

(22) Filed: Mar. 13, 2026

(30) Foreign Application Priority Data
Mar. 14, 2025 (JP) 2025-041044

(51) Int. Cl. B41J 11/70

(52) U.S. Cl. CPC B41J 11/70

(57) ABSTRACT

A roll paper printer includes a cutter device having a first blade and a second blade configured to be able to cut a medium wound in a roll shape, and the first blade has a first groove part and a first base part, moves toward the second blade, is configured to be able to perform full cutting of the medium in which the medium is cut over an entire width thereof, after passing through a position where partial cutting in which an uncut part is left uncut by the first groove part can be performed, and has a recessed surface having a thickness thinner than that of the first base part, around the first groove part.

The present application is based on, and claims priority from JP Application Serial Number 2025-041044, filed Mar. 14, 2025, the disclosure of which is hereby incorporated by reference herein in its entirety.

### BACKGROUND

### 1. Technical Field

The present disclosure relates to a roll paper printer.

### 2. Related Art

According to the related art, as disclosed in JP-A-2001-239494, a printer including a cutter device that can partially cut and fully cut a paper wound in a roll shape is known.

JP-A-2001-239494 is an example of the related art.

However, in the above-described printer including the cutter device, a paper fragment may be generated at the time of full cutting.

### SUMMARY

According to an aspect of the present disclosure, a roll paper printer includes a cutter device having a first blade and a second blade configured to be able to cut a medium wound in a roll shape, in which the first blade has a first groove part and a first base part, moves toward the second blade, is configured to be able to perform full cutting of the medium in which the medium is cut over an entire width thereof, after passing through a position where partial cutting in which an uncut part is left uncut by the first groove part can be performed, and has a recessed surface having a thickness thinner than that of the first base part, around the first groove part.

According to another aspect of the present disclosure, a roll paper printer includes a cutter device having a third blade and a second blade configured to be able to cut a medium wound in a roll shape, in which the third blade has a second groove part and a second base part, moves toward the second blade, is configured to be able to perform full cutting of the medium in which the medium is cut over an entire width thereof, after passing through a position where partial cutting in which an uncut part is left uncut by the second groove part can be performed, and has a sloped surface having a thickness thinner than that of the second base part and inclined toward the second blade, around the second groove part.

### BRIEF DESCRIPTION OF THE DRAWINGS

FIG. 1 is a cross-sectional view of a roll paper printer having a cutter device.

FIG. 2 is a front view of the cutter device.

FIG. 3 is a front view of a first movable blade during partial cutting.

FIG. 4 is a schematic view showing a cut state when a medium is partially cut.

FIG. 5 is a front view of the first movable blade during full cutting.

FIG. 6 is a schematic view showing a cut state when a folded medium is partially cut.

FIG. 7 is a front view of the first movable blade having a recessed surface according to a first embodiment.

FIG. 8 is a cross-sectional view of the first movable blade taken along a line A-A in FIG. 7.

FIG. 9 is a plan view of the first movable blade of FIG. 7.

FIG. 10 is a front view of a second movable blade having a sloped surface according to a second embodiment.

FIG. 11 is a cross-sectional view of the second movable blade taken along a line B-B of FIG. 10.

FIG. 12 is a plan view of the second movable blade shown in FIG. 10.

### DESCRIPTION OF EMBODIMENTS

Hereinafter, embodiments will be described with reference to the drawings. Note that directions in the drawings are described, using a three-dimensional coordinate system. For the sake of convenience of description, a positive direction on a Z axis is referred to as an upward direction or simply as above, a negative direction thereon is referred to as a downward direction or simply as below, a positive direction on an X axis is referred to as a rightward direction or simply as right, a negative direction thereon is referred to as a leftward direction or simply as left, a positive direction on a Y axis is referred to as a forward direction or simply as front, and a negative direction thereon is referred to as a rearward direction or simply as rear.

### 1. Configuration of Roll Paper Printer

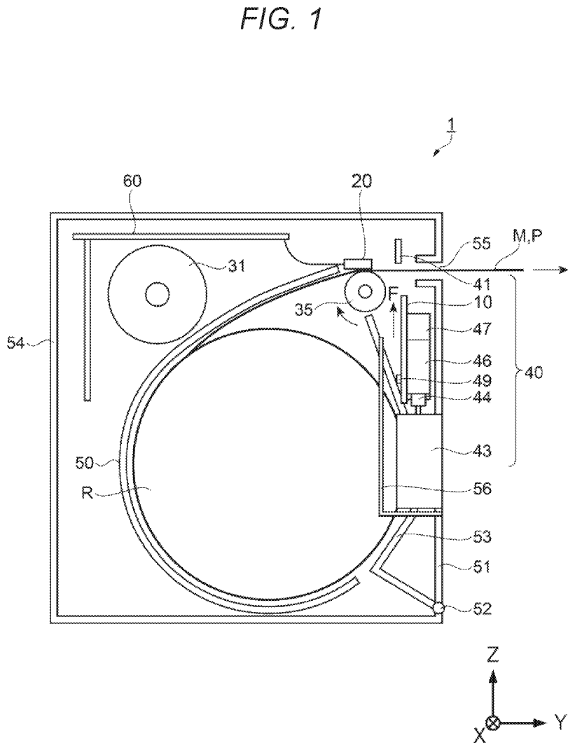

FIG. 1 shows a roll paper printer 1 having a cutter device 40. Hereinafter, the roll paper printer 1 is simply referred to as a printer 1.

The printer 1 includes a case 54, a cover 51, and an accommodation unit 50 that accommodates a roll paper R formed of a medium M round in a roll shape. As will be described later, the cover 51 and the case 54 include a plurality of components.

The cover 51 is attached to the case 54 so as to be rotatable about a hinge 52. When the cover 51 rotates clockwise about the hinge 52 and is opened, the accommodation unit 50 is opened and the user can place the roll paper R therein for accommodation.

A conveyance roller 35 is provided in the cover 51. The conveyance roller 35 is driven by a conveyance motor 31 provided in the case 54 in a state where the cover 51 is closed.

A head 20 is provided in the case 54. When the cover 51 is closed, the conveyance roller 35 together with the head 20 can sandwich the medium M. The conveyance roller 35 rotates clockwise and can pull out and convey the medium M from the roll paper R. The head 20, which is a thermal head, can perform printing by heating the medium M, which is a thermal paper. The printed medium M is conveyed along a medium path P in the conveyance direction, which is the forward direction, and is discharged from a discharge port 55.

The case 54 is provided with a substrate 60 where a control unit (not shown) including a processor and a memory is mounted. The processor can read and execute a program from the memory and thus control each part of the printer 1.

### 2. Configuration of Cutter Device

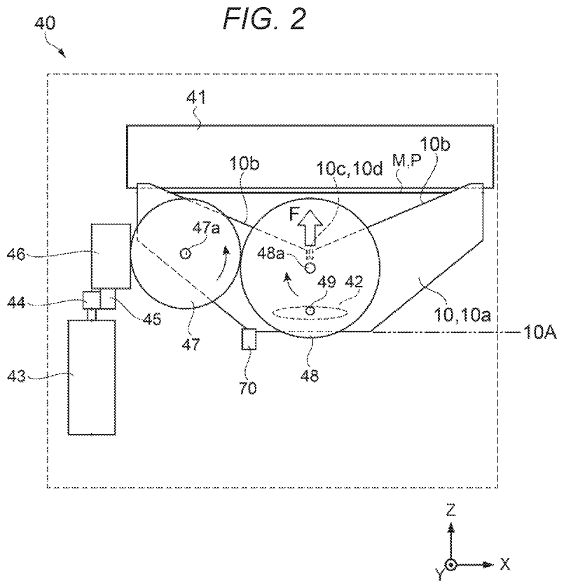

As shown in FIGS. 1 and 2, the cutter device 40 includes a first movable blade 10, which is a first blade, a movable blade motor 43, a gear 44 of the movable blade motor 43, a transmission gear 45, a worm 46, a worm wheel 47, a gear 48, a pin 49 provided on the gear 48, a cutter case 56 accommodating these components, and a fixed blade 41, which is a second blade. The configuration of the first movable blade 10 will be described in detail later.

Among these components, the fixed blade 41 is provided in the case 54, and the other components are provided in the cover 51. When the cover 51 is closed, the first movable blade 10 is at a position facing the fixed blade 41.

The medium M is conveyed along the medium path P between the first movable blade 10 and the fixed blade 41 facing each other and is thus cut.

As shown in FIG. 2, the torque of the movable blade motor 43 is transmitted to the gear 44, the transmission gear 45, the worm 46, and the worm wheel 47 in this order, and the worm wheel 47 rotates counterclockwise about a worm wheel shaft 47a. The worm 46 together with the worm wheel 47 forms a so-called worm gear. The gear 48 meshes with the worm wheel 47 and rotates clockwise about a gear shaft 48a.

The pin 49 is provided on the gear 48. The pin 49 is slidably fitted in an elongated hole 42 formed in the first movable blade 10. With the clockwise rotation of the gear 48, the pin 49 rotates clockwise, too, and moves the first movable blade 10 in a cutting direction F while sliding on the edge of the elongated hole 42. The cutting direction F is an upward direction and a direction in which the first movable blade 10 moves toward the fixed blade 41.

The first movable blade 10 is regulated by left and right guides (not shown). The first movable blade 10 and the elongated hole 42 can linearly move in the cutting direction F without rotating with the rotation of the pin 49. That is, the rotational motion of the gear 48 is converted into the linear motion of the first movable blade 10 by the pin 49 and the elongated hole 42.

The cutter device 40 is a so-called cut-off-type cutter or a push-type cutter, in which the first movable blade 10 is moved toward the fixed blade 41.

FIG. 2 shows the first movable blade 10 at a first position 10A, which is a standby position before the first movable blade 10 moves.

The first movable blade 10 is formed of a V-shaped metal. Both sides of the V shape of the first movable blade 10 are first blade edges 10b formed by sharpening the upper ends thereof. In the description below, in order to simplify the description, one first blade edge 10b will be mainly described, but the same applies to the other first blade edge 10b.

The fixed blade 41 is formed of a rectangular metal, and the end of the lower side thereof facing the first movable blade 10 is sharpened.

At the first position 10A, both ends of the V shape of the first movable blade 10 are superimposed on and brought into contact with the fixed blade 41 from the front. The medium path P is formed between the fixed blade 41, which is on the upper side, and the first movable blade 10, which is on the lower side, and the medium M is conveyed forward along the medium path P.

Although not shown in the drawings, a central part of the first movable blade 10 is in a slightly bent posture so as to be pushed toward the fixed blade 41 located to the rear, as will be described later. The first movable blade 10 can smoothly slide with respect to the fixed blade 41 from the ends of the first blade edges 10b on both sides of the V shape toward the center.

At the center of the V shape of the first movable blade 10, a recessed first groove part 10c that is cut out in a rectangular shape is formed. The first groove part 10c is also referred to as a cutout. A first end part 10d is formed at the lower end of the first groove part 10c.

At corners on both sides of the first groove part 10c in the cutting direction F, first edges 10e are formed in the front-rear direction and in the thickness direction of the first movable blade 10. In FIG. 2, the first edges 10e are omitted for the sake of convenience of illustration.

An example in which the first movable blade 10 moves in the cutting direction F to cut the medium M will be described with reference to FIGS. 2 to 6.

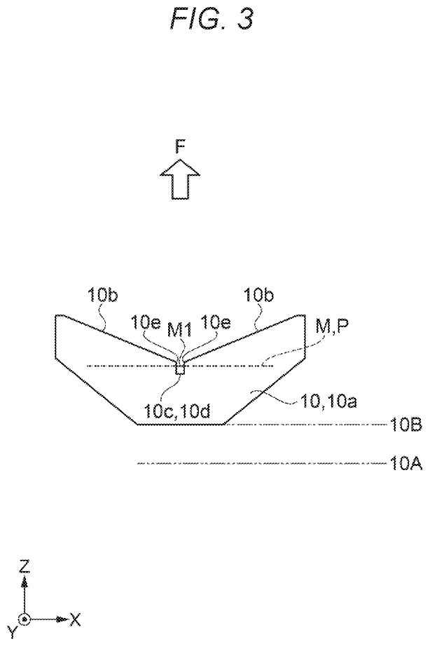

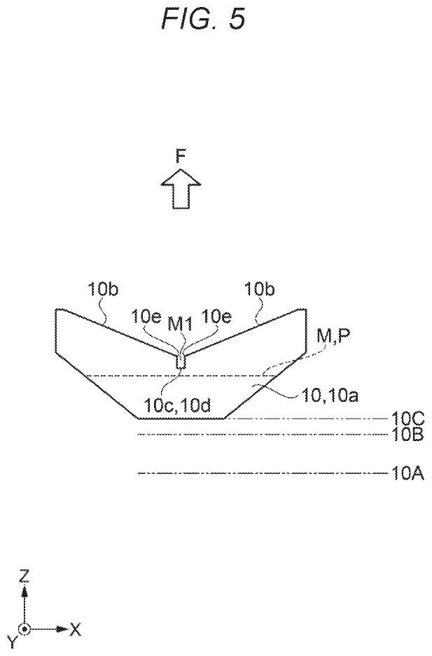

As the position of the first movable blade 10, the first position 10A shown in FIG. 2, a second position 10B shown in FIG. 3, and a third position 10C shown in FIG. 5 are shown as the position of the lower end of the first movable blade 10 when moving in the cutting direction F, for the sake of convenience.

In FIGS. 3 and 5, although components similar to those of the cutter device 40 in FIG. 2 are originally provided, components other than the first movable blade 10 are omitted in order to illustrate the position of the first movable blade 10 in an easy-to-understand manner.

As shown in FIG. 2, a sensor 70 can detect the position of the first movable blade 10. The control unit mounted at the substrate 60 can cause the movable blade motor 43 to move the first movable blade 10 to a target position while causing the sensor 70 to detect the position of the first movable blade 10. In the description below, the control of the movable blade motor 43 by the control unit using the sensor 70 will be omitted.

As shown in FIG. 2, when the first movable blade 10 is at the first position 10A, which is a standby position before moving, the pin 49 of the gear 48 is at the lowermost point.

The movable blade motor 43 starts driving and rotates the pin 49 to move the first movable blade 10 in the cutting direction F, which is upward.

When the first movable blade 10 moves toward the fixed blade 41 facing the first movable blade 10, the V-shaped first blade edges 10b intersect the fixed blade 41 from the ends to the center. The position of intersection is also a position where the blade edges of the first blade edges 10b and the fixed blade 41 are in point contact with each other. The medium M is sandwiched between the first blade edges 10b and the fixed blade 41 and is cut at the position of point contact.

It is now assumed that the first movable blade 10 reaches the second position 10B from the first position 10A, as shown in FIG. 3. At the time of partial cutting, described later, the movable blade motor 43 stops driving, and the first movable blade 10 stops at the second position 10B.

At the second position 10B, the first end part 10d of the first groove part 10c of the first movable blade 10 does not reach the position of the medium M. The medium M is cut from both sides by the first blade edges 10b of the first movable blade 10 and is not yet cut by the first end part 10d of the first groove part 10c. In the medium M, an uncut part M1 having a first width 10G, described later, which is the width of the first groove part 10c, is left uncut.

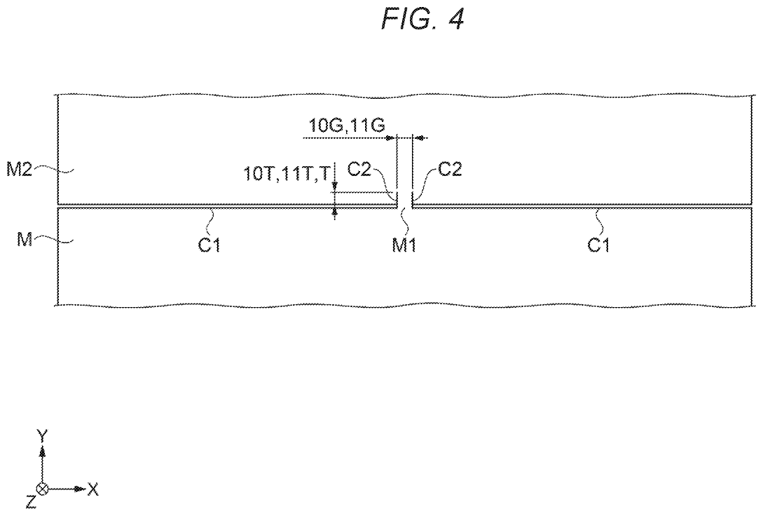

As illustrated in FIG. 4, parts on both side of the medium M are cut as first cut parts C1 by the first blade edges 10b on both sides of the first movable blade 10. A front part of the medium M that is cut is referred to as a cut medium M2.

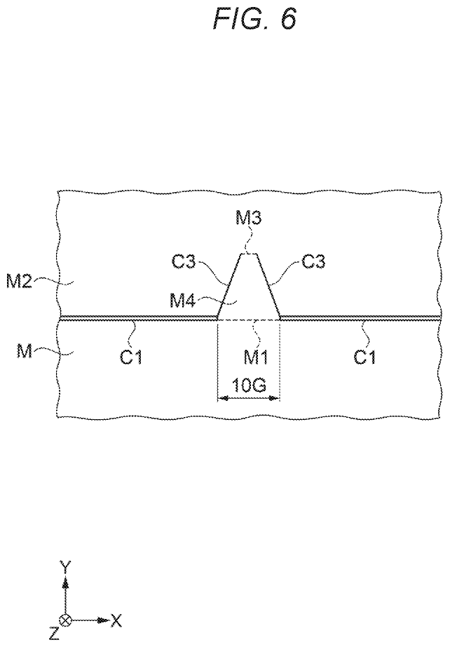

The first movable blade 10 has the first edges 10e at the corners on both sides of the first groove part 10c. After the first cut part C1 are cut, the medium M is further cut forward in the shape of slits as second cut parts C2 by the first edges 10e on both sides of the uncut part M1. The second cut parts C2 will be described in detail later. As described later, FIG. 4 shows a case where the second cut parts C2 are not inclined, unlike third cut parts C3 in FIG. 6.

The cut medium M2 cut in this manner is in a state of being partially in continuation with the medium M at the uncut part M1, which is the central part.

When the first movable blade 10 is moved to the second position 10B and is stopped there by the movable blade motor 43, the first movable blade 10 cuts the medium M, leaving the uncut part M1. In this way, the first movable blade 10 can perform so-called partial cutting in which the medium M is partially cut. That is, the first movable blade 10 can perform the partial cutting with the first groove part 10c at the second position 10B. The uncut part M1 forms the first width 10G of the first groove part 10c, described later.

When the movable blade motor 43 rotates reversely after the partial cutting, the first movable blade 10 can return from the second position 10B to the first position 10A.

It is now assumed that the first movable blade 10 does not stop at the second position 10B but moves further in the cutting direction F and reaches the third position 10C, as shown in FIG. 5.

At the third position 10C, the first end part 10d of the first groove part 10c of the first movable blade 10 is beyond the position of the medium M. The first end part 10d can cut the uncut part M1 of the medium M. While FIG. 5 shows the position of the uncut part M1 corresponding to FIG. 3 for reference, the uncut part M1 is cut in practice.

In this way, after the medium M is cut by the first blade edges 10b on both sides of the first movable blade 10, the uncut part M1 shown in FIG. 4 left uncut at the central part is cut by the first end part 10d of the first groove part 10c. The medium M is completely fully cut, and the cut medium M2 is cut off from the medium M.

When the first movable blade 10 is moved to the third position 10C by the movable blade motor 43, the medium M is cut over the entire width and so-called full cutting can be performed. That is, the first movable blade 10 can perform the partial cutting at the second position 10B and then perform the full cutting at the third position 10C.

After the full cutting, when the movable blade motor 43 stops and then reversely rotates, the first movable blade 10 can return from the third position 10C to the first position 10A. When the pin 49 of the gear 48 is at the uppermost point (not illustrated), the first movable blade 10 can return from the third position 10C to the first position 10A when the movable blade motor 43 continues to be driven without stopping.

Incidentally, since the first groove part 10c of the first movable blade 10 is recessed toward the back, which is downward, and has a structure with a narrow width, it is difficult to perform machining for sharpening as in the first blade edges 10b. The first groove part 10c including the first end part 10d and the first edge 10e is in a state of having a cross section formed by simply die-cutting a metal.

Since the first end part 10d and the first edge 10e are not sharpened, the first end part 10d and the first edge 10e push and tear the medium M.

Here, the second cut part C2 will be described in detail. When the first movable blade 10 performs the partial cutting, the first blade edge 10b cuts the first cut part C1, and subsequently the first edge 10e of the first groove part 10c pushes the medium M and cuts the second cut part C2 like tearing off this part, as shown in FIG. 4. The second cut part C2 is formed so as to be in continuation with the first cut part C1.

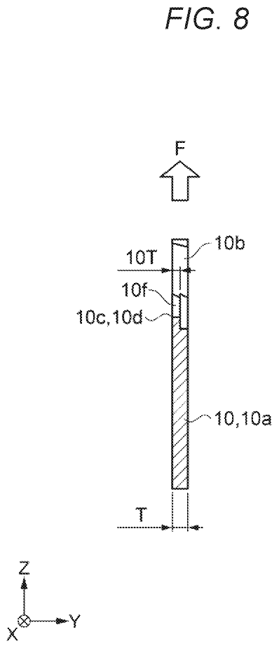

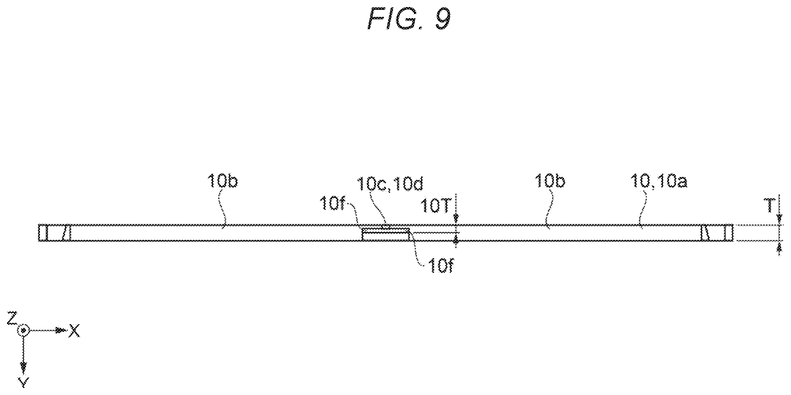

The length of the second cut part C2 approximates the length of the first edge 10e in the front-rear direction. As illustrated in FIG. 4, the length of the first edge 10e in the front-rear direction is a thickness T of a first base part 10a of the first movable blade 10, described later with reference to FIGS. 8 and 9. The length of the second cut part C2 is a length approximate to the thickness T.

As shown in FIG. 3, at the first groove part 10c, the part between the first edges 10e on both sides is recessed toward the first end part 10d.

Since the first edges 10e on both sides are not sharpened, the first edges 10e push the cut medium M2. At this time, also due to a frictional force between the moving first movable blade 10 and the first cut part C1, the cut medium M2 between the first edges 10e on both sides is curved and bent along the shape of the recess of the first groove part 10c. The folding is also referred to as turning up of the cut medium M2.

Since the first cut parts C1 on both sides are already cut, the cut medium M2, while being bent, is torn forward from the end of the first cut part C1, which is the end of the uncut part M1.

That is, the first edges 10e on both sides tear and cut the cut medium M2 forward from both ends of the uncut part M1 while bending the cut medium M2 in the cutting direction F. The “forward” is also the direction in which the conveyance roller 35 conveys the medium M.

FIG. 6 illustrates the result of cutting the cut medium M2 when the cut medium M2 is strongly bent by the first edge 10e. The first edge 10e tears the medium from the end of the uncut part M1 and cuts the medium as the third cut parts C3. The third cut parts C3 correspond to the non-inclined second cut parts C2 in FIG. 4.

Since the first edges 10e on both sides tear the cut medium M2 forward from both ends of the uncut part M1 while strongly bending the cut medium M2 from both sides, the third cut parts C3 on both sides are cut so as to be inclined toward the center.

Specifically, the third cut part C3 is cut so as to be inclined toward the center as it goes forward away from the end of the uncut part M1 located to the rear of the cut medium M2. As a result, the third cut part C3 is inclined such that the width of an uncut end part M3 on the front side is narrower than the width of the uncut part M1 on the rear side.

The magnitude of the inclination of the third cut part C3 is related to the strength of the bending of the cut medium M2. For example, the strength of the bending increases and the inclination of the third cut part C3 increases as the length of the first edge 10e increases, the width 10G of the first groove part 10c, described later, decreases, and the like.

An increase in the length of the first edge 10e means an increase in the thickness T of the first base part 10a of the first movable blade 10. As will be described later, when the medium M has a large thickness, when the medium M has a high rigidity and has a so-called high stiffness, or the like, it is preferable to increase the thickness T of the first base part 10a of the first movable blade 10. However, the inclination of the third cut part C3 increases.

In the partial cutting, the user pulls the cut medium M2 and thus tears off and takes out the uncut part M1. At this time, the medium M connected at the uncut part M1 may be pulled out. In order to prevent the medium M from being pulled out, it is preferable to narrow the width of the uncut part M1 so that the uncut part M1 can be easily torn off.

In order to narrow the uncut part M1, it is preferable to narrow the first width 10G of the first groove part 10c, described later. However, the inclination of the third cut part C3 increases.

When the thickness T of the first base part 10a of the first movable blade 10 is increased, or when the first width 10G of the first groove part 10c is narrowed or the like, the inclination of the third cut part C3 increases, as illustrated in FIG. 6. As a result, the width of the uncut end part M3 is narrowed.

The uncut end part M3 having a reduced width is easily torn off. When the first movable blade 10 moves, the uncut end part M3 may be torn off and cut.

When the first movable blade 10 performs the full cutting, if the first end part 10d of the first movable blade 10 cuts the uncut part M1 after the uncut end part M3 is torn off and cut, a paper fragment M4, which is the uncut part M1 cut on the front side and the rear side, may be generated. Since the uncut end part M3 has a narrower width than the uncut part M1, the paper fragment M4 has a triangular or trapezoidal shape.

When the paper fragment M4 separated from the cut medium M2 enters the cutter device 40 or a component of the printer 1, a problem may occur due to jamming or the like.

### 3. First Movable Blade According to First Embodiment

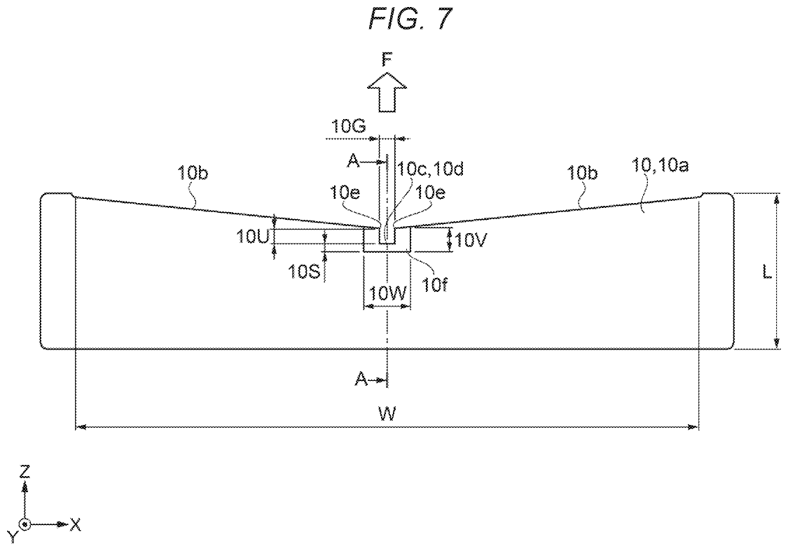

The configuration of the first movable blade 10 according to a first embodiment will be described with reference to FIGS. 7 to 9. As described above, the first movable blade 10 is provided in the cutter device 40.

The first movable blade 10 includes the first base part 10a serving as a base, the first blade edges 10b on both sides of the V shape that are sharpened, a recessed surface 10f which is a recessed surface having a thinner thickness than the first base part 10a, the first groove part 10c formed at the recessed surface 10f, and the first end part 10d at the lower end of the first groove part 10c.

The first edges 10e are formed at the corners on both sides of the first groove part 10c in the cutting direction F. The first edge 10e is formed as an edge along the thickness direction of the recessed surface 10f, which is the front-rear direction. That is, the recessed surface 10f is formed around the first groove part 10c including the first edge 10e.

In FIGS. 8 and 9, the illustration of the first edge 10e is omitted for the sake of convenience of illustration.

The first movable blade 10 has dimensions of a cutting width W, which is a width with which the first movable blade 10 can cut the medium M, and a blade length L. The cutting width W is preferably about 5 mm wider than the width of the medium M to be cut. The blade length L is preferably, for example, 20 mm.

The first groove part 10c has dimensions of the first width 10G and a first depth 10U. The first width 10G is preferably 1.5 mm to 2.0 mm. The first depth 10U is preferably 2 mm.

The recessed surface 10f has dimensions of a recessed surface width 10W, a recessed surface length 10V, and a first overstroke length 10S, which is an overstroke at the time of full cutting. The recessed surface width 10W is preferably four times the minimum value of the first width 10G or more, and is preferably 6 mm or more. The recessed surface length 10V is preferably 3 mm. The first overstroke length 10S is preferably 1 mm.

As illustrated in FIGS. 8 and 9, the first base part 10a of the first movable blade 10 has a dimension of a thickness T. When the width of the medium M is 80 mm, 100 mm, and 120 mm, the thickness T is preferably 1.0 mm to 1.2 mm, 1.2 mm to 1.4 mm, and 1.4 mm to 1.6 mm, respectively.

The recessed surface 10f has a dimension of a first thickness 10T thinner than the thickness T. The first thickness 10T is preferably 0.1 mm to 0.6 mm.

Meanwhile, when the medium M has a large thickness or the medium M has a high rigidity, that is, a high stiffness, the load on the cutter device 40 in cutting the medium M increases, and the first movable blade 10 is likely to be separated from the fixed blade 41, that is, the first movable blade 10 tends to float, as it is called. When the first movable blade 10 floats from the fixed blade 41, the first movable blade 10 cannot slide and the medium M cannot be cut.

Therefore, the central part of the first movable blade 10 is configured to be pressed against the fixed blade 41 by an elastic member such as a spring (not shown) so that the first movable blade 10 does not float from the fixed blade 41. By the pressing force of the elastic member, the first movable blade 10 comes into contact with the fixed blade 41 such that the central part is slightly bent. In order to achieve normal cutting, the bending needs to be within an appropriate range.

In order to achieve the bending of the first movable blade 10 within an appropriate range, it is preferable to increase the thickness T of the first movable blade 10.

As described above with reference to FIG. 6, the magnitude of the inclination of the third cut part C3 is related to the strength of the bending of the cut medium M2. The strength of the bending of the cut medium M2 is related to the thickness T of the first movable blade 10. When the thickness T of the first movable blade 10 is increased, the inclination of the third cut part C3 increases and the paper fragment M4 is likely to be generated.

Therefore, in the first movable blade 10 according to the first embodiment, the recessed surface 10f, which is a rectangular recessed surface having the first thickness 10T thinner than the thickness T of the first base part 10a, is formed around the first groove part 10c including the first edge 10e. The first end part 10d of the first groove part 10c, too, has the first thickness 10T, which is the same as the recessed surface 10f. In the present application, the meaning of the term “same” in the first thickness 10T, which is the same as the recessed surface 10f, includes substantially the same.

The length of the first edges 10e at the corners on both sides of the first groove part 10c in the cutting direction F is shorter, since this length, too, is equivalent to the first thickness 10T, which is the same as the thickness of the recessed surface 10f. Therefore, the length of the first edge 10e is shorter than the thickness T of the first base part 10a. Since the first edge 10e is thinner and sharper, the cut medium M2 is easily cut.

As the length of the first edge 10e decreases, the strength of the bending of the cut medium M2 also decreases. As a result, the inclination of the third cut part C3 decreases and the width of the uncut end part M3 increases.

Note that the above-described FIG. 4 also shows a case where the second cut part C2 is not inclined unlike the third cut part C3 in FIG. 6 because the length of the first edge 10e is sufficiently short or the like. The length of the third cut part C3 is equivalent to the first thickness 10T. The width of the uncut end part M3 is equivalent to the first width 10G of the first groove part 10c.

With the first movable blade 10 as described above, the uncut end part M3 is less likely to be torn off, and the generation of the paper fragment M4 is suppressed when the first movable blade 10 moves in the full cutting or the like.

In the first movable blade 10, since the thickness T of the first base part 10a in continuation with the first blade edge 10b is not as thin as the first thickness 10T, the medium M having a large thickness or the medium M having a high stiffness can also be cut by the first blade edge 10b.

### 4. Second Movable Blade According to Second Embodiment

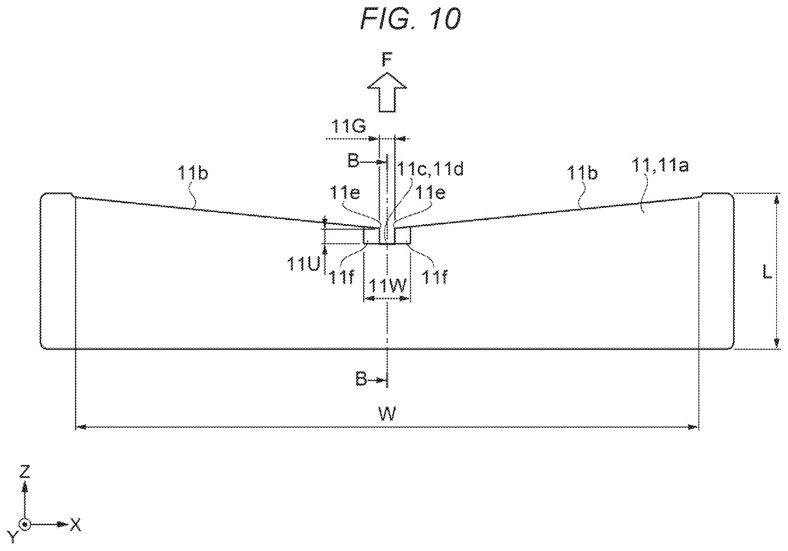

The configuration of a second movable blade 11, which is a third blade according to a second embodiment, will be described with reference to FIGS. 10 to 12. The second movable blade 11 is provided in the cutter device 40 similarly to the above-described first movable blade 10.

The second movable blade 11 includes a second base part 11a serving as a base, second blade edges 11b on both sides of the V shape that are sharpened, a sloped surface 11f inclined such that the thickness decreases toward the cutting direction F, a second groove part 11c formed in the sloped surface 11f, and a second end part 11d at the lower end of the second groove part 11c of the sloped surface 11f. The cutting direction F is an upward direction and a direction toward the fixed blade 41.

The sloped surface 11f may be formed only on both left and right sides of the second groove part 11c. The sloped surface 11f has a thinner thickness than the second base part 11a and is formed to be inclined in the cutting direction F.

Second edges 11e are formed at the corners on both sides of the second groove part 11c in the cutting direction F. The second edge 11e is formed as an edge along the thickness direction of the upper distal end part of the sloped surface 11f, which is the front-rear direction. That is, the sloped surface 11f is formed around the second groove part 11c including the second edge 11e.

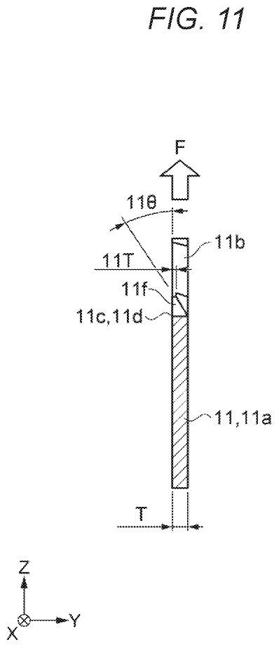

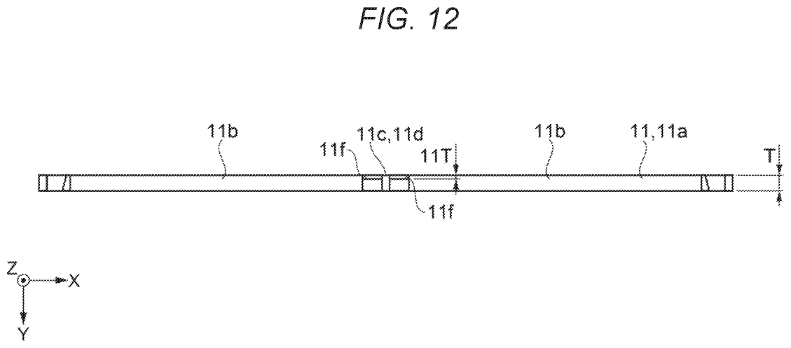

In FIGS. 11 and 12, the illustration of the second edge 11e is omitted for the sake of convenience of illustration. The second edge 11e corresponds to the first edge 10e of the first movable blade 10 and can similarly cut the second cut part C2 and the third cut part C3 in the medium M.

The second movable blade 11 has the same dimensions in the following parts corresponding to the first movable blade 10.

The second movable blade 11 has dimensions of a cutting width W and a blade length L similar to those of the first movable blade 10. The second groove part 11c has a dimension of a second width 11G similar to the first width 10G, and a dimension of a second depth 11U similar to the first depth 10U.

These dimensions of the second movable blade 11 may be different from those of the first movable blade 10.

As shown in FIG. 11, the sloped surface 11f is inclined by an angle 110 so as to become thinner toward the cutting direction F. The second end part 11d of the second groove part 11c may also have a sloped surface in continuation with the sloped surface 11f.

As shown in FIGS. 11 and 12, the second base part 11a of the second movable blade 11 has a dimension of a thickness T. In the sloped surface 11f, the upper tip part is the thinnest and has a dimension of a second thickness 11T. In the sloped surface 11f, the lower part is the thickest but preferably has a dimension equal to or less than the thickness T.

The sloped surface 11f has a dimension of a sloped surface width 11W. The sloped surface width 11W is preferably three times the minimum value of the second width 11G or more, and preferably 4.5 mm or more.

The angle 110 is preferably 20° to 30°. The angle 110 is more preferably 24° to 26°. The second thickness 11T is preferably 0.3 mm.

The second base part 11a of the second movable blade 11 has the same dimension of the thickness T as the first base part 10a of the first movable blade 10.

As described above, when the thickness T of the second base part 11a is increased, the inclination of the third cut part C3 shown in FIG. 6 increases, and the paper fragment M4 is likely to be generated.

Therefore, the second movable blade 11 according to the second embodiment has the sloped surface 11f that has a thinner thickness than the second base part 11a and is inclined toward the cutting direction F, around the second groove part 11c.

The length of the second edges 11e at the corners on both sides of the second groove part 11c in the cutting direction F is shorter, since this length, too, is equivalent to the second thickness 11T, which is the same as the thickness of the distal end part of the sloped surface 11f. Therefore, the length of the second edge 11e is shorter than the thickness T of the second base part 11a. Since the second edge 11e is thinner and sharper, the cut medium M2 is easily cut. In the present application, the meaning of the term “same” in the second thickness 11T, which is the same as the thickness of the distal end part of the sloped surface 11f, includes substantially the same.

As the length of the second edge 11e decreases, the inclination of the third cut part C3 decreases and the width of the uncut end part M3 increases.

FIG. 4 also shows a case where the third cut part C3 is not inclined because the length of the second edge 11e is sufficiently short, or the like. The length of the third cut part C3 is equivalent to the second thickness 11T. The width of the uncut end part M3 is equivalent to the second width 11G of the second groove part 11c.

With the second movable blade 11 as described above, the uncut end part M3 is less likely to be torn off, and the generation of the paper fragment M4 is suppressed when the second movable blade 11 moves in the full cutting or the like.

In the second movable blade 11, since the thickness T of the second base part 11a in continuation with the second blade edge 11b is not as thin as the second thickness 11T, the medium M having a large thickness or the medium M having a high stiffness can be cut by the second blade edge 11b.

As described above, the printer 1 according to the first embodiment includes the cutter device 40 including the first movable blade 10 and the fixed blade 41 that can cut the medium M wound in a roll shape as the roll paper R.

The first movable blade 10 includes the first groove part 10c and the first base part 10a. The first movable blade 10 moves in the cutting direction F toward the fixed blade 41, passes through the second position 10B where the partial cutting of the medium M is performed in which the uncut part M1 is left by the first groove part 10c, and then can perform the full cutting in which the medium M is cut over the entire width thereof, at the third position 10C.

The first movable blade 10 has the recessed surface 10f having the first thickness 10T thinner than the thickness T of the first base part 10a, around the first groove part 10c.

According to the printer 1 having such a configuration, in the first movable blade 10, the length of the first edges 10e at the corners on both sides of the first groove part 10c in the cutting direction F is shorter since this length, too, is equivalent to the first thickness 10T, which is the same as the thickness of the recessed surface 10f. Therefore, the length of the first edge 10e is shorter than the thickness T of the first base part 10a.

When the length of the first edge 10e decreases, the inclination of the third cut part C3 decreases, the width of the uncut end part M3 increases, the uncut end part M3 is less likely to be torn off, and the generation of the paper fragment M4 is suppressed when the first movable blade 10 moves in the full cutting or the like. Particularly, it is effective when increasing the thickness T of the first base part 10a of the first movable blade 10 or decreasing the first width 10G of the first groove part 10c.

Also, as described above, the printer 1 according to the second embodiment includes the cutter device 40 including the second movable blade 11 and the fixed blade 41 that can cut the medium M wound in a roll shape as the roll paper R.

The second movable blade 11 includes the second groove part 11c and the second base part 11a. The second movable blade 11 moves in the cutting direction F toward the fixed blade 41, passes through the second position 10B where the partial cutting of the medium M is performed in which the uncut part M1 is left by the second groove part 11c, and then can perform the full cutting in which the medium M is cut over the entire width thereof, at the third position 10C.

The second movable blade 11 has the sloped surface 11f that is a thinner thickness than the second base part 11a and is inclined so as to be thinner toward the fixed blade 41, around the second groove part 11c.

According to the printer 1 having such a configuration, in the second movable blade 11, the length of the second edges 11e at the corners on both sides of the second groove part 11c in the cutting direction F is shorter since this length, too, is equivalent to the second thickness 11T, which is the same as the thickness of the distal end part of the sloped surface 11f. Therefore, the length of the second edge 11e is shorter than the thickness T of the second base part 11a.

When the length of the second edge 11e decreases, the inclination of the third cut part C3 decreases, the width of the uncut end part M3 increases, the uncut end part M3 is less likely to be torn off, and the generation of the paper fragment M4 is suppressed when the second movable blade 11 moves in the full cutting or the like. Particularly, it is effective when increasing the thickness T of the second base part 11a of the second movable blade 11 or decreasing the second width 11G of the second groove part 11c.

While the embodiments have been described in detail with reference to the drawings, the specific configurations are not limited to the embodiments, and may be changed, replaced, deleted or the like without departing from the spirit and scope of the disclosure.

In the above description, the head 20 is a thermal head, and the medium M is a thermal paper, but the head 20 may be an inkjet head, and the medium M may be a normal paper, a film, or the like.

What is claimed is:

1. A roll paper printer comprising a cutter device having a first blade and a second blade configured to be able to cut a medium wound in a roll shape, wherein
the first blade
has a first groove part and a first base part,
moves toward the second blade and is configured to be able to perform full cutting of the medium in which the medium is cut over an entire width thereof, after passing through a position where partial cutting in which an uncut part is left uncut by the first groove part can be performed, and
has a recessed surface having a thickness thinner than that of the first base part, around the first groove part.

2. The roll paper printer according to claim 1, wherein
the first blade has first edges at corners on both sides of the first groove part,
the first edges on both sides are configured to be able to cut the medium into a slit shape on both sides of the uncut part, and
a length of the first edge is the same as a thickness of the recessed surface.

3. A roll paper printer comprising a cutter device having a third blade and a second blade configured to be able to cut a medium wound in a roll shape, wherein
the third blade
has a second groove part and a second base part,
moves toward the second blade and is configured to be able to perform full cutting of the medium in which the medium is cut over an entire width thereof, after passing through a position where partial cutting in which an uncut part is left uncut by the second groove part can be performed, and
has a sloped surface having a thickness thinner than that of the second base part and inclined toward the second blade, around the second groove part.

4. The roll paper printer according to claim 3, wherein
the third blade has second edges at corners on both sides of the second groove part,
the second edges on both sides are configured to be able to cut the medium into a slit shape on both sides of the uncut part, and
a length of the second edge is the same as a thickness of a distal end part of the sloped surface.
